(19) United States
(12) Patent Application Publication
(10) Pub. No.: US 2007/0048198 A1
(43) Pub. Date: Mar. 1, 2007

(54) Method for inserting a ceramic functional body in a tubular metal housing and a device thus produced

(75) Inventor: Frank Terres, Frankeneck (DE)

Correspondence Address: MCGRATH, GEISSLER, OLDS & RICHARDSON, PLLC, P.O. BOX 1364, FAIRFAX, VA, 22038-1364, US

(73) Assignee: Heinrich Gillet GmbH

(21) Appl. No.: 11/513,283

(22) Filed: Aug. 31, 2006

(30) Foreign Application Priority Data
Sep. 1, 2005 (DE) 10 2005 041 512

(51) Int. Cl. B01D 50/00

(52) U.S. Cl. 422/180

(57) ABSTRACT

A method for inserting a ceramic functional body in a tubular metal housing is disclosed. After the functional body is measured, it is wrapped with a support mat and slid into the housing. This is followed by a heating step of the entire housing. In this state, the housing is then reduced to a dimension that results from the current dimension of the ceramic functional body plus the desired gap dimension in the hot state. Upon cooling, the housing shrinks, and the functional body and the support mat sit correctly in the housing.

This nonprovisional application claims priority under 35 U.S.C. § 119(a) on German Patent Application No. DE 2005041512, which was filed in Germany on Sep. 1, 2005, and which is herein incorporated by reference.

### BACKGROUND OF THE INVENTION

1. Field of the Invention

The present invention relates to a method for inserting a ceramic functional body in a tubular metal housing. The invention further relates to a device thus produced.

2. Description of the Background Art

Ceramic functional bodies are used as catalysts and as diesel exhaust particulate filters in exhaust systems for motor vehicles with internal combustion engines. The ceramic functional bodies are located in a metal housing, which has a sheet metal jacket, an intake cone, and an outlet cone. In order to be able to compensate for the different coefficients of thermal expansion of metal and ceramic, the ceramic bodies are wrapped in a suitable support mat and inserted in the housing. So that the ceramic functional body remains fixed in place in the metal housing when the ambient temperature drops to −30° C., for example, or when the exhaust temperatures reach temperatures of up to 900° C., the dimensions of the metal housing, the support mat, and the ceramic functional body must be precisely matched to one another.

Unfortunately, ceramic functional bodies have large diameter tolerances on account of the manufacturing process. It is necessary, therefore, to measure each ceramic body in order to be able to determine the appropriate metal housing for it. This is rather costly.

It has already been proposed to utilize an oversized metal housing and to size the metal housing after the insertion of the ceramic body wrapped with the support mat. U.S. Pat. No. 5,055,274 shows such a sizing process using a sizing tool having sizing dies. EP 0 768 451 A shows a method in which the metal housing is sized with the aid of pressure rollers.

Since the sheet metal of the housing has the property of springing back subsequent to the sizing, i.e. after the reduction in diameter, the diameter must first be reduced to an increased degree. This presents the risk that the ceramic functional body will be damaged. Since the housing is already closed, this damage can no longer be detected. Moreover, the function of the support mat is significantly damaged by the brief overcompression. Consequently, the methods for after-the-fact sizing of the metal housing described in the above cited documents have not achieved implementation.

### SUMMARY OF THE INVENTION

It is therefore an object of the present invention to provide a method by which an after-the-fact sizing of the housing can be performed without the risk of damage to the ceramic functional body or to the support mat.

At least two advantages are achieved thanks to the heating of the housing before the reduction in diameter. Firstly, the heated and the thus softened sheet metal material can be deformed with the application of little force, and has only a minimal tendency to spring back. Secondly, the diameter of the housing only needs to be reduced to the maximum diameter value that the housing will take on in operation under the greatest heating, as a result of which only minimal forces are exerted on the support mat and ceramic body, precluding any damage. As soon as the housing is cooled to ambient temperature, the ceramic functional body sits correctly in the housing.

The heating of the housing preferably takes place by inductive heating. Alternatively, or in addition, the housing can also be heated by, for example, a flame.

The housing is preferably heated to red or white heat, corresponding to temperatures up to 900° C.

The heated housing can be sized in a manner known per se by sizing tools or also by pressure rollers.

The subject matter of the invention also includes devices produced in accordance with the invention for treating exhaust gases of internal combustion engines. These are catalytic converters or exhaust particulate filters with ceramic functional bodies. In order to keep the mechanical stress on the ceramic as low as possible, the housing is heated up to, for example, 900° C. during the sizing process and is sized to a dimension calculated from the diameter of the functional body and the thickness of the support mat.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates an insertion in a tubular metal housing of a ceramic functional body wrapped in a support mat;

FIG. 2 shows a heating of the housing;

FIG. 3 illustrates a sizing of the heated housing to the diameter dimension corresponding to the ceramic functional body by sizing dies; and

FIG. 4 illustrates a sizing by pressure rollers.

### DETAILED DESCRIPTION

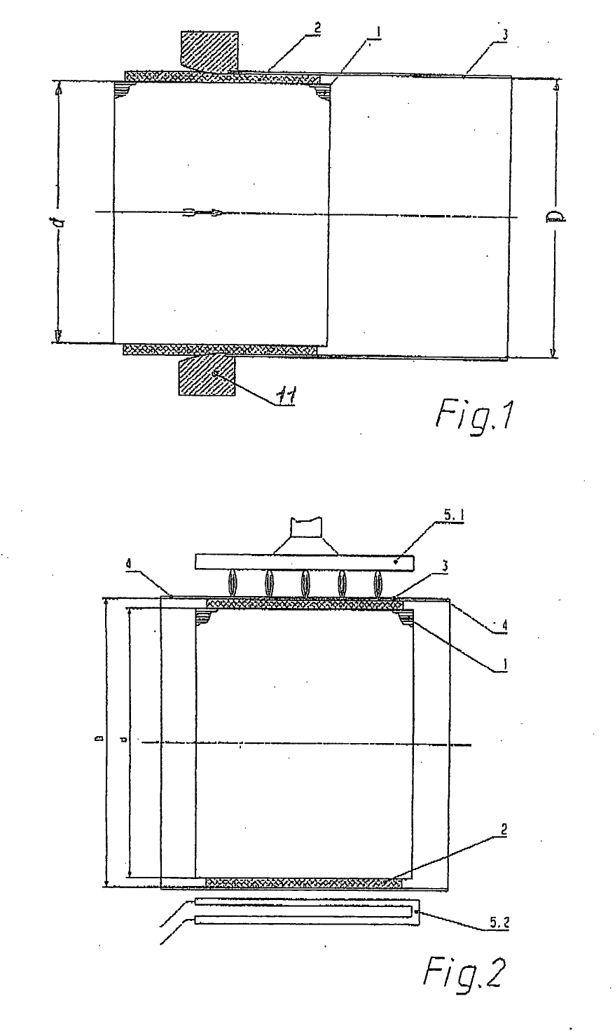

The sequence of the inventive method is described in a purely schematic fashion on the basis of FIGS. 1 through 4.

First, a ceramic functional body 1, for example a catalytic converter or diesel exhaust particulate filter, is measured. The diameter d, in particular, is determined in this process. In the case of oval functional bodies, multiple diameters are measured.

The ceramic functional body 1 is then wrapped with a support mat 2.

In FIG. 1, the wrapped functional body 1, 2 is inserted in a tubular housing 3 with the aid of a funnel 11. The housing 3 has a significant oversize D. As a result, the support mat 2 is almost completely uncompressed. It experiences no shear forces. The ceramic body 1 and support mat 2 can be precisely positioned within the housing 3. The support mat 2 retains its position, and the ceramic body 1 cannot become canted.

After the wrapped ceramic body 1, 2 has been slid in, the housing 3 is heated to red or white heat in approximately 5 seconds, as shown in FIG. 2. An induction coil 5.2 is preferably used in this regard. Alternatively, or in addition, heating by a flame 5.1 is also possible. The ends 4 of the housing 3 need not be heated.

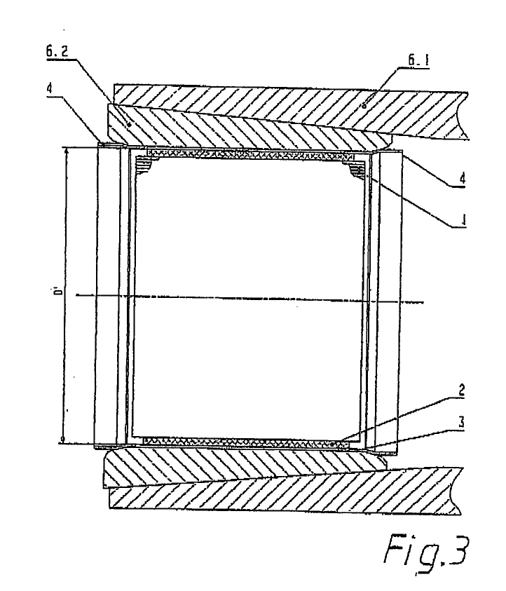

FIG. 3 shows how the heated housing 3 is sized with the aid of sizing dies 6.1, 6.2. In this process, its diameter D′ in the hot state is sized to the diameter dimension d determined in FIG. 1, plus the shrinkage allowance.

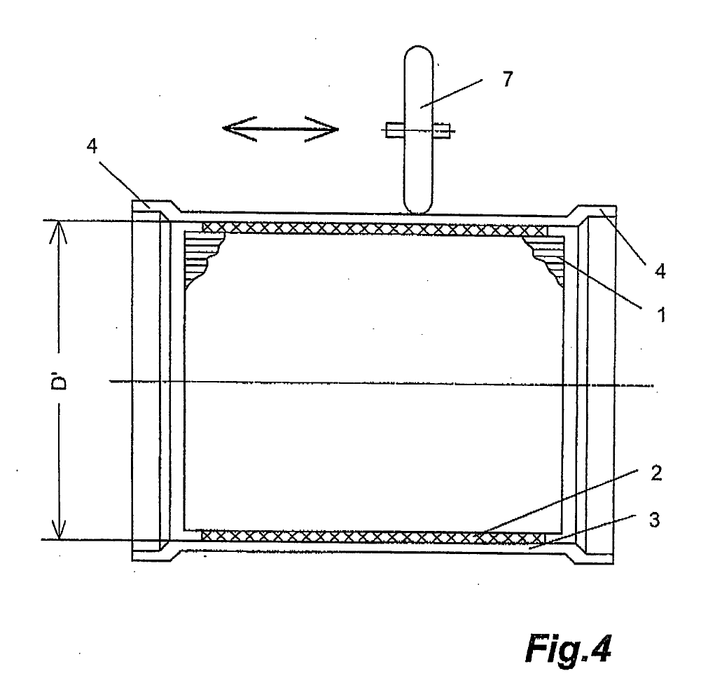

FIG. 4 shows how the heated housing 3 is sized to the dimension D′ with the aid of a pressure roller 7.

During the subsequent cooling, the housing 3 shrinks to the desired final dimension, during which process the support mat 2 is compressed to the desired value in the safest manner. Neither the ceramic body 1 nor the support mat 2 can be damaged in this process. The ceramic functional body 1 retains its operating position within the housing 3 in all operating states.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for inserting a ceramic functional body in a tubular metal housing, the method comprising the steps of:
measuring the functional body;
wrapping the functional body with a support mat;
sliding the wrapped functional body into the housing;
heating the housing;
reducing the housing diameter subsequent to the heating step; and
cooling the housing after the step of reducing the housing diameter, until the functional body and support mat are seated.

2. The method according to claim 1, wherein the housing is heated by inductive heating.

3. The method according to claim 1, wherein the housing is heated by a flame.

4. The method according to claim 1, wherein the housing is heated to red or white heat.

5. The method according to claim 1, wherein the diameter of the housing is reduced via sizing dies.

6. The method according to claim 1, wherein the diameter of the housing is reduced via pressure rollers.

7. A device for treating exhaust gases of internal combustion engines, the device comprising:
a tubular housing;
a ceramic functional body; and
a support mat provided between the functional body and the housing,
wherein, in an area of the support mat, the housing is heated and is sized in the heated state to a dimension of the functional body plus a dimension of the support mat.
